(19) United States
(12) Patent Application Publication
(10) Pub. No.: US 2025/0239894 A1
(43) Pub. Date: Jul. 24, 2025

(54) INSTALLATION FOR THE INDUCTIVE TRANSFER OF ELECTRIC POWER AND METHOD FOR OPERATING AN INSTALLATION

(71) Applicant: SEW-EURODRIVE GMBH & CO. KG, Bruchsal (DE)

(72) Inventors: Thomas UHL, Bruchsal (CN); Valentin KUHFUß, Stutensee (DE); Christian TREIER, Offenbach an der Queich (DE); Thomas KREMPEL, Hambrücken (DE); Alexander KIST, Karlsruhe (DE)

(73) Assignee: SEW-EURODRIVE GMBH & CO. KG, Bruchsal (DE)

(21) Appl. No.: 18/703,464

(22) PCT Filed: Sep. 28, 2022
(86) PCT No.: PCT/EP2022/077069

§ 371 Date: Apr. 22, 2024

(30) Foreign Application Priority Data
Oct. 20, 2021 (DE) 10 2021 005 231.5

(51) Int. Cl. H02J 50/80; H02J 50/12

(52) U.S. Cl. CPC H02J 50/80; H02J 50/12

(57) ABSTRACT

In an installation for the inductive transfer of electric power from a primary conductor system of the installation to a secondary winding of a mobile part of the installation, the mobile part being movable relative to the primary conductor system, and method for operating an installation, the secondary winding is connected to capacitors so as to form an oscillating circuit; a sensor for capturing the value of a physical variable is disposed on the mobile part, the signal of which sensor is provided to a comparison device which generates an output signal depending on the result of the comparison of the value with a threshold value; the mobile part has an overvoltage protector which can be activated and/or deactivated depending on an actuation signal; and the actuation signal is generated by an OR-gate which is provided firstly with a first data flow signal to be transferred from the mobile part to the primary side, and secondly with the output signal.

### FIELD OF THE INVENTION

The present invention relates to an installation for the inductive transfer of electric power and to a method for operating an installation.

### BACKGROUND INFORMATION

In certain conventional systems, electric power is transmitted inductively in transformers.

A primary circuit device is described in PCT Patent Document No. WO 2022/002240.

A plant with a protection module is described in German Patent Document No. 10 2006 022 223.

### SUMMARY

Example embodiments of the present invention improve the operational safety of installations.

According to example embodiments of the present invention, in an installation for the inductive transfer of electric power from a primary conductor system, e.g., from a primary winding or from a primary conductor arranged in an elongated manner in the installation, of the installation to a secondary winding of a mobile part of the installation, the mobile part is movable relative to the primary conductor system. For example, an alternating current having a frequency is between 10 kHz and 1 MHz, e.g., between 20 kHz and 100 kHz, is impressed into the primary conductor system. The secondary winding is connected to capacitors so as to form an oscillating circuit, e.g., a series oscillating circuit. A sensor for capturing the value of a physical variable, e.g., temperature, voltage, and/or current, is disposed on the mobile part, the signal of which sensor is provided to a comparison device which generates an output signal depending on the result of the comparison of the value with a threshold value. The mobile part has an overvoltage protector which can be activated and/or deactivated depending on an actuation signal, and the actuation signal is generated by an OR-gate which is provided firstly with a first data flow signal to be transferred from the mobile part to the primary side, and secondly with the output signal.

Thus, when the physical variable has permissible values, the overvoltage protector is used for data transfer, and when the physical variable has impermissible values, the overvoltage protector is used to reduce or switch off the transfer of electrical power. Thus, no special additional effort is necessary but an extension of the software is substantially sufficient.

According to example embodiments, the voltage provided to the primary conductor system is modulated with a second data stream, e.g., for the transfer of a second data stream from the primary part to the mobile part or the current impressed into the primary conductor system is modulated with a second data stream. The second data stream is filtered out and/or demodulated from the curve of the current passing through the secondary winding captured by a sensor or from the curve of a level for the voltage induced in the secondary winding or for a voltage occurring at the oscillating circuit captured by a sensor. Thus, the overvoltage protector can be used for the first direction of data transfer and another effective method can be used for the other direction of data transfer. This is because it is readily possible to modulate the voltage and current on the primary side and the effect of this is readily possible to detect on the secondary side.

According to example embodiments, the overvoltage protector of the mobile part has a controllable switch, e.g., a triac, via which the oscillating circuit can be detuned and/or via which at least a partial region of the oscillating circuit can be short-circuited. Thus, the overvoltage protector can be activated with minimal effort.

According to example embodiments, the mobile part has a controllable switch via which the oscillating circuit can be detuned and/or via which at least a partial region of the oscillating circuit can be short-circuited.

Thus, the inductive transfer can be terminated after a risk has been detected, e.g., after a threshold value has been exceeded, e.g., at a voltage of a current or a temperature.

Thus, operational safety can be improved. As only the translated current flows through the short-circuit connection when the oscillating circuit is detuned, no overload of the short-circuit connection is to be expected.

According to example embodiments, the capacitors are connected in series with the secondary winding, e.g., forming a series circuit. An AC/DC converter is supplied from the series circuit, e.g., the series circuit is disposed and/or connected at the AC-side connection of the AC/DC converter, and a consumer can be fed from the DC-side connection of the AC/DC converter, e.g., to which consumer a smoothing capacitor is connected in parallel. Thus, a high degree of efficiency can be achieved even with a weak inductive coupling between the primary conductor system and the secondary winding.

According to example embodiments, the partial region is determinable or determined by a connecting element. Thus, depending on the respective installation, a different partial region can be short-circuited in each case.

According to example embodiments, the connecting element is a variably equipable bridge, a switch, or a bridge equipped on a printed circuit board. Thus, a cost-effective realization of a flexibly selectable connection can be achieved.

According to example embodiments, an actuation signal is fed to the controllable switch from an actuator of the mobile part, and the actuator is connected to one or more sensors. For example, the actuation signal is generated by the actuator in dependence on the values of physical variables of the mobile part captured by the sensor or sensors. Thus, the transfer of electrical power can be switched off depending on the detected state.

According to example embodiments, the or one of the sensors detects the value of the temperature of the secondary winding and/or is suitably disposed on the mobile part, e.g., arranged as an infrared temperature sensor for contactless capturing of the temperature of the secondary winding. Thus, the transfer of electrical power can be switched off in the event of overtemperature, allowing for increased operational safety. For example, the risk of fire can be reduced.

According to example embodiments, the or one of the sensors detects the value of the temperature of the AC/DC converter, e.g., rectifier or controllable rectifier, secondary winding and/or is suitably disposed on the mobile part, being, for example, arranged as an infrared temperature sensor for contactless capturing of the temperature of the AC/DC converter. Thus, the transfer of electrical power can be switched off in the event of overtemperature, allowing for increased operational safety. For example, the risk of fire can be reduced.

According to example embodiments, the or one of the sensors captures the value of the voltage applied at the DC-side or AC-side connection of the AC/DC converter, e.g., the rectifier or controllable rectifier, and/or is suitably disposed on the mobile part. Thus, the transfer of electrical power can be switched off in the event of overvoltage, allowing for increased operational safety. For example, the voltage breakdown and thus the risk of fire can be reduced.

According to example embodiments, the or one of the sensors detects the value of the current flowing through the secondary winding and/or is suitably disposed on the mobile part. Thus, the transfer of electrical power can be switched off in the event of overcurrent, allowing for increased operational safety. For example, the risk of fire can be reduced.

According to example embodiments, the or one of the sensors captures the value of the current entering or exiting the DC-side connection of the AC/DC converter and/or is suitably disposed on the mobile part. Thus, the transfer of electrical power can be switched off in the event of overcurrent, allowing for increased operational safety. For example, the risk of fire can be reduced.

According to example embodiments, the actuator has a comparison device which compares the values of the respective physical variable or variables of the mobile part captured by the sensor or sensors with a respective threshold value, and the actuator generates the actuation signal for the controllable switch in dependence on the output signal of the comparison device and/or in dependence on the result of the comparison. Thus, the transfer of electrical power can be switched off in the event of a threshold value being exceeded, allowing for increased operational safety. For example, the risk of fire can be reduced.

According to example embodiments, the actuator monitors the values of the respective physical variable or variables of the mobile part captured by the sensor or sensors for exceeding an impermissible level of deviation from a setpoint value, and the actuator generates the actuation signal for the controllable switch in dependence on the output signal of the monitoring and/or in dependence on the result of the monitoring. Thus, the transfer of electrical power can be switched off in the event of a permissible level of deviation being exceeded, allowing for increased operational safety.

According to example embodiments, the actuator is arranged such that monitoring for an impermissibly high level of deviation from a functional relationship, e.g., from a proportionality, of the values captured by two of the sensors is carried out, e.g., carried out by the actuator, and the actuator generates the actuation signal for the controllable switch in dependence on the result of the monitoring. Thus, an abnormal operating state is immediately recognizable and damage can be avoided by switching off the power transfer, thus in particular reducing the risk of fire and increasing operational safety.

According to example embodiments, in a method for operating an installation: electrical power is transferred from a primary conductor system of the installation to a secondary winding of a mobile part of the installation, the mobile part being movable relative to the primary conductor system; the secondary winding is connected to capacitors to form an oscillating circuit which feeds a rectifier whose output voltage is supplied to a consumer; values of physical variables of the mobile part are captured and monitored for an impermissibly high level of deviation from a functional relationship, e.g., from a proportionality; and depending on the result of the monitoring, the oscillating circuit is detuned or at least a partial region of the oscillating circuit is short-circuited.

Thus, an abnormal operating state is immediately recognizable, and damage can be avoided by switching off the power transfer, e.g., reducing the risk of fire and increasing operational safety.

According to example embodiments, a first of the physical variables of the mobile part is the temperature of the oscillating circuit, and a second of the physical variables of the mobile part is the temperature of the rectifier, and, to monitor for an impermissibly high level of deviation from the functional relationship, the quotient is formed from the captured values of the two physical variables and monitored for an impermissibly high level of deviation from a setpoint value. Thus, the risk of fire resulting from an abnormal operating condition can be avoided.

According to example embodiments, the output signal is fed to the first OR-gate via a second OR-gate, to which first OR-gate an enable signal is also fed, so that the transfer of a data packet of the data stream signal that has already commenced is still fully executed after the threshold value has been exceeded. Thus, the data stream signal includes data packets, e.g., the duration of the transfer of the data packets is less than the thermal time constant of the mobile part with sensor. Thus, in the event of overtemperature, the switch is delayed until the current data packet, the transfer of which had just commenced, is still fully transferred, and only after this does the switch reduce or switch off the power. Since the transfer time for the data packet is shorter than the thermal time constant, the switch-off is sufficiently fast to prevent overtemperature, for example.

Further features and aspects of example embodiments of the present invention are explained in more detail below with reference to the appended schematic Figures.

### BRIEF DESCRIPTION OF THE DRAWINGS

FIG. 1 illustrates the secondary part of an installation for the inductive transfer of electrical power.

FIG. 2 illustrates an installation, in which a triac is used as controllable switch 2.

FIG. 3 illustrates the connection technology for the triac.

FIG. 4 illustrates the secondary part of an installation with bidirectional communication.

FIG. 5 is a block diagram that illustrates the communication.

FIG. 6 illustrates a current curve on the secondary side as a function of a voltage curve on the primary side.

### DETAILED DESCRIPTION

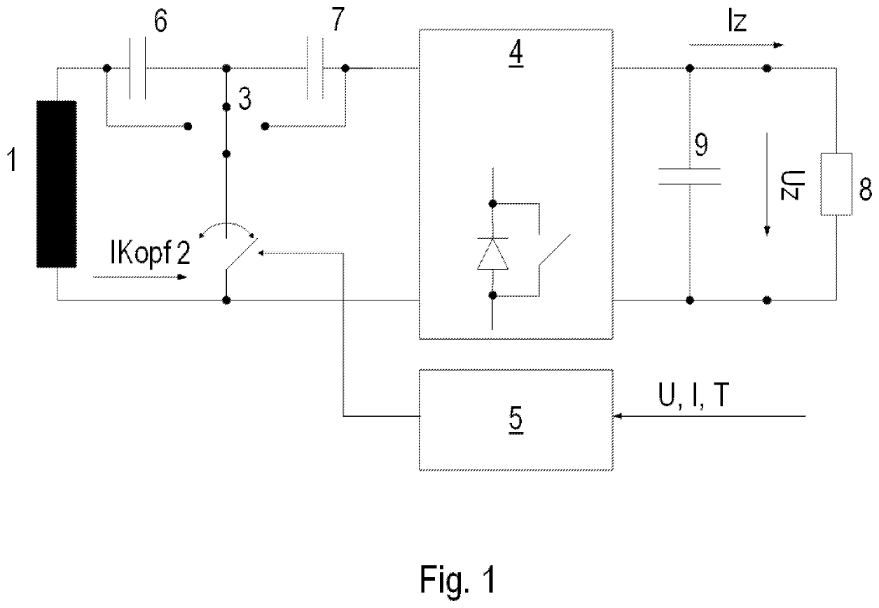

As illustrated in FIG. 1, the installation has a primary conductor system, which, for example, has a line conductor arranged in an elongated manner in the installation. A mobile part disposed movably along the primary conductor system has a secondary winding 1 which is provided inductively coupled to the primary conductor system.

An alternating current is applied to the primary conductor system, and the frequency of the alternating current is, for example, a medium frequency. For example, a frequency between 10 kHz and 1 MHz is used as the frequency of the alternating current.

As illustrated in FIG. 1, during resonant operation, the secondary winding 1 is connected in series to capacitors 6, 7, e.g., a first capacitor 6 and a second capacitor 7, in which these are dimensioned such that the oscillating circuit formed by the capacitors 6, 7 and the secondary winding 1 has a resonant frequency which is equal to the frequency of the alternating current impressed into the primary conductor system. Thus, even with only a weak inductive coupling of the primary conductor circuit to the secondary winding 1, a high degree of efficiency can be achieved during transfer.

The oscillating circuit feeds a rectifier 4, which is, for example, arranged to be controlled, whose output voltage feeds a consumer 8 and a smoothing capacitor 9 disposed in parallel therewith.

The output voltage is captured by a sensor and monitored for exceeding a first threshold value by an electronic controller connected to the sensor, which controller is also arranged as an actuator 5 for a controllable switch 2, e.g., a controllable semiconductor switch.

In the closed state, the controllable switch 2 causes detuning of the oscillating circuit by bridging part of the oscillating circuit.

Which part is bridged can be determined by a connecting element 3, e.g., by a variably equipable bridge, a switch, or a bridge equipped on a printed circuit board. For example, in a first configuration of the connecting element 3, a short circuit of the secondary winding itself is achieved. In another configuration of the connecting element 3, a part of the oscillating circuit is short-circuited, which includes the secondary winding 1 and a first capacitor 6, in which a second capacitor 7 of the oscillating circuit does not belong to this short-circuited part. In a third configuration, the entire oscillating circuit is short-circuited, i.e., the input of the rectifier 4.

Thus, in all the above-mentioned configurations of the connecting element 3, the oscillating circuit is detuned or short-circuited such that practically no voltage is available at the input of the rectifier 4, even if a voltage is induced at the secondary winding 1.

When the switch 2 is in the open state, the oscillating circuit remains untuned so that the full voltage generated by the oscillating circuit is applied at the input of the rectifier 4.

When the first threshold value is exceeded, the switch 2 is closed and thus the connecting element 3 becomes active such that no voltage is made available at the input of the rectifier 4. When the voltage falls below the first threshold value, the switch 2 is opened and thus the full voltage which can be generated by the oscillating circuit is made available at the input of the rectifier 4.

Instead of or in addition to the sensor for capturing the output voltage, a sensor for capturing the temperature of the rectifier 4 and/or of the oscillating circuit 1 can also be provided. Thus, the switch 2 can also be closed when a further threshold value is exceeded, providing a protective effect for the arrangement. This is because there is a risk of fire in the event of overtemperature.

Instead of the sensors mentioned or in addition to one of these sensors or to these sensors, a sensor can be provided for capturing a current, e.g., the current of the secondary winding 1 or the output current at the rectifier 4, to monitor if a third threshold value is exceeded. The switch 2 is thus closed when a current threshold value is exceeded.

In configurations in which a plurality of sensors is present, the switch 2 is closed as soon as a single one of all threshold values is exceeded. Switch 2 is thus only opened if none of the threshold values are exceeded.

At least one energy storage of the mobile part can also be provided as consumer 8, from which energy storage the drive of the mobile part is supplied. For example, the energy storage is a capacitor, e.g., an ultracapacitor.

In certain configurations, a hysteresis is provided around the respective threshold value.

In certain configurations, a sensor for capturing the temperature of the secondary winding and a sensor for capturing the temperature of the rectifier 4 are provided. This monitors whether or not the two captured temperatures change in a predicted manner.

For example, in a first configuration, if there is an unacceptably large deviation from the proportionality of the two temperatures, the switch 2 is actuated such that the switch closes. Otherwise, the switch 2 remains open, e.g., if the value of a respective physical variable captured by one or a plurality of other sensors does not exceed a respective threshold value. For calculating purposes, the quotient of the two captured temperatures can be formed in a simple manner, and the quotient is then monitored for an impermissibly large level of deviation from a setpoint value. Monitoring for undercutting and exceeding corresponding threshold values is also mathematically comparable.

Instead of proportionality, another relationship can also be used and a corresponding deviation can be monitored.

In certain configurations, the deviation from a particular relationship, e.g., the deviation from proportionality, of the values captured by two of the sensors is also monitored and the switch 2 is closed depending on the result of the monitoring, e.g., when an impermissibly high level of deviation from a setpoint value is exceeded.

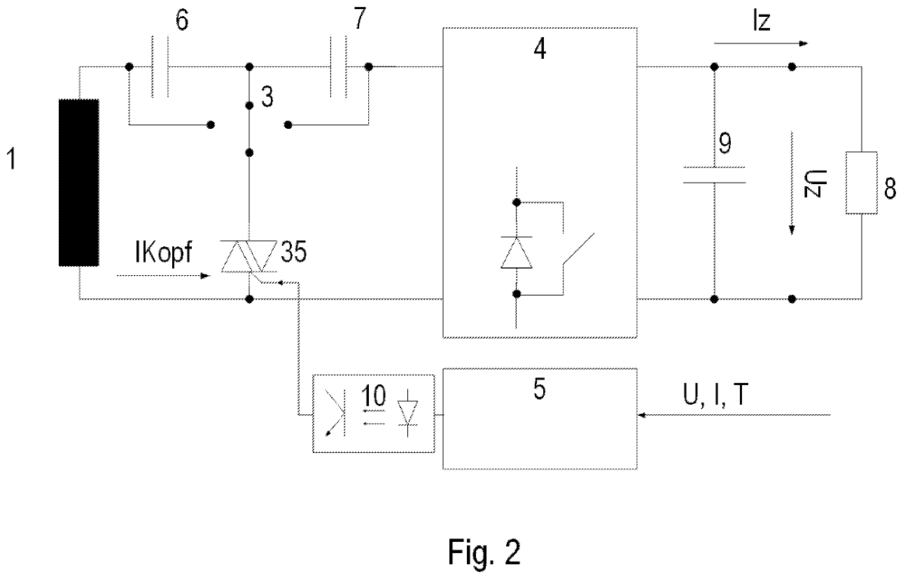

As illustrated in FIG. 2, the controllable switch can be arranged as a triac, which is galvanically isolated from the actuator 5 and can be controlled via an optocoupler.

The TRIAC is activated by a control current into the control connection and conducts in both directions equally. If the control signal is removed, the TRIAC would extinguish at the next current zero crossing if it were operated at low frequency, e.g., at a mains frequency of 50 Hz or 60 Hz.

However, since it is operated with a medium-frequency alternating current, e.g., with an alternating current whose frequency is between 10 kHz and 1 MHz, e.g., between 20 kHz and 100 kHz, the triac conducts after activation until the effective value of the alternating current becomes zero. This is because the frequency of the alternating current is so high that the component cannot reach the blocking state during the current zero crossings. The conductive state of the component thus only ceases when the secondary winding 1 is no longer magnetically flooded by the primary conductor system of the installation.

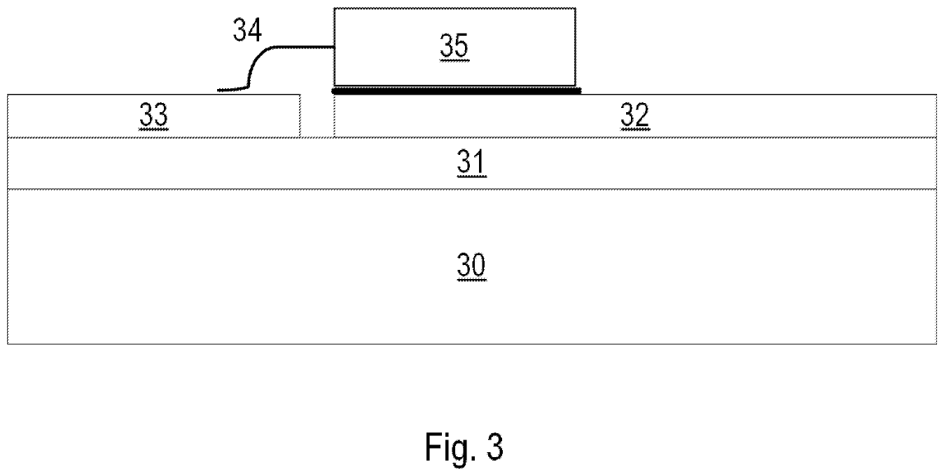

As illustrated in FIG. 3, the controllable switch 2, which is arranged as a triac, is disposed as an SMD component on a printed circuit board. This printed circuit board has a metal carrier 30, e.g., made of aluminum or copper, in which an insulation layer 31 is disposed on the metal carrier 30 for electrical insulation.

Conductor track sections 32, 33 are disposed on the insulation layer 31, e.g., on the side of the insulation layer 31 facing away from the metal carrier 30, which are used for electrical contacting and for holding the triac.

A connecting plate 34 of the triac 35 is soldered to one of the conductor track sections 32, 33, and a metallic outer surface of the triac 35 is in contact with another conductor track section 32, 33 and is soldered thereto.

The insulation layer is electrically insulating but has very good thermal conductivity. The heat loss of the triac is thus efficiently distributed via the conductor track sections 32, 33, the insulation layer 31 and the metal carrier 30. Thus, the triac can also be exposed to currents of more than 10 amperes, e.g., more than 30 or even 100 amperes.

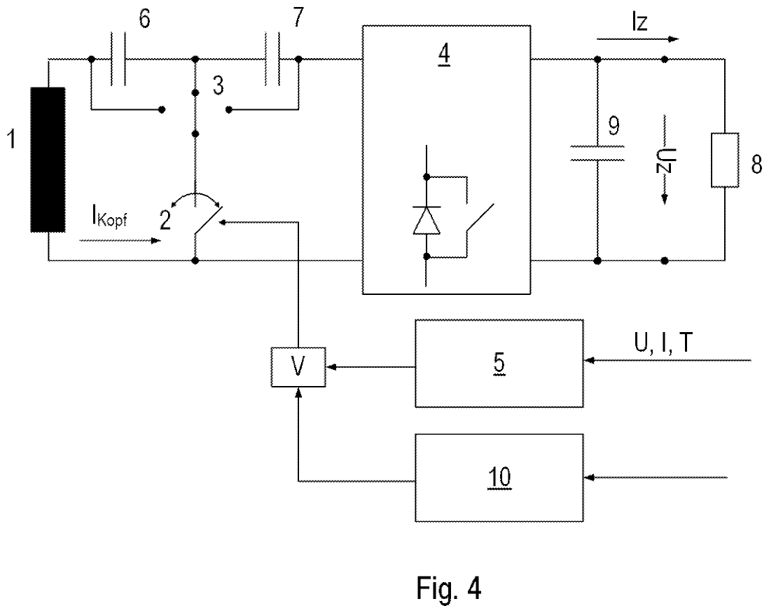

As illustrated in FIG. 4, bidirectional communication is possible in an installation, as described herein.

For this purpose, the signal supplied by the actuator 5 is fed to an OR-gate (V), to which the data signal supplied by a communication circuit 10 is also fed.

The OR-linked output signal of the OR-gate V is used as the actuation signal for the controllable switch 2.

Thus, if the voltage, current or temperature does not exceed or fall below a threshold value, the actuator 5 accordingly supplies a zero signal, which only leads to the closing of the controllable switch 2 and thus to the detuning of the oscillating circuit on the secondary side if a corresponding signal is supplied by the communication circuit 10.

The detuning therefore takes place according to the data stream to be transferred.

As a result of a detuning of the oscillating circuit on the secondary side, the load on the primary side then decreases, so that the voltage applied to the primary conductor drops accordingly, because a current source is realized on the primary side.

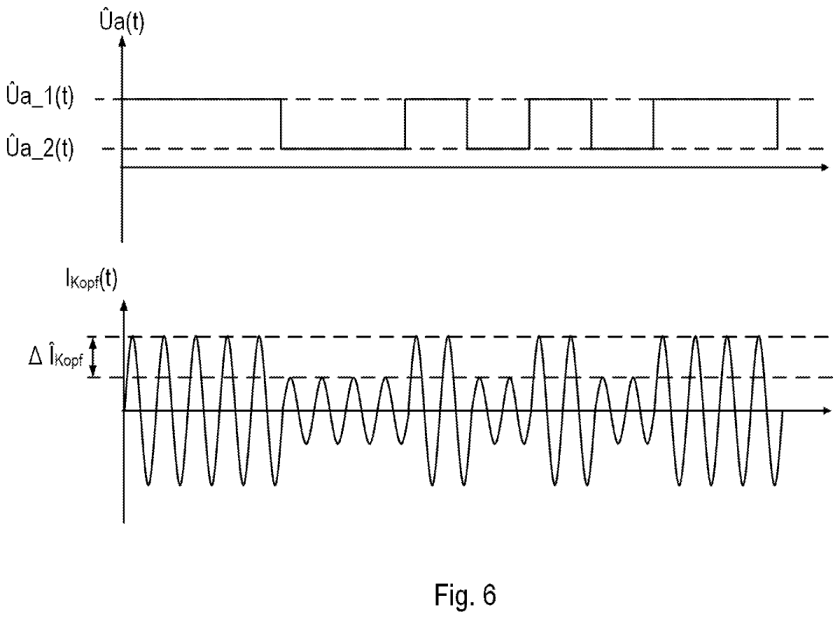

As illustrated in FIG. 6, however, it is also possible to transfer data from the primary side to the secondary side by modulating the voltage applied to the primary winding, which leads to a corresponding modulation of the current curve on the secondary side.

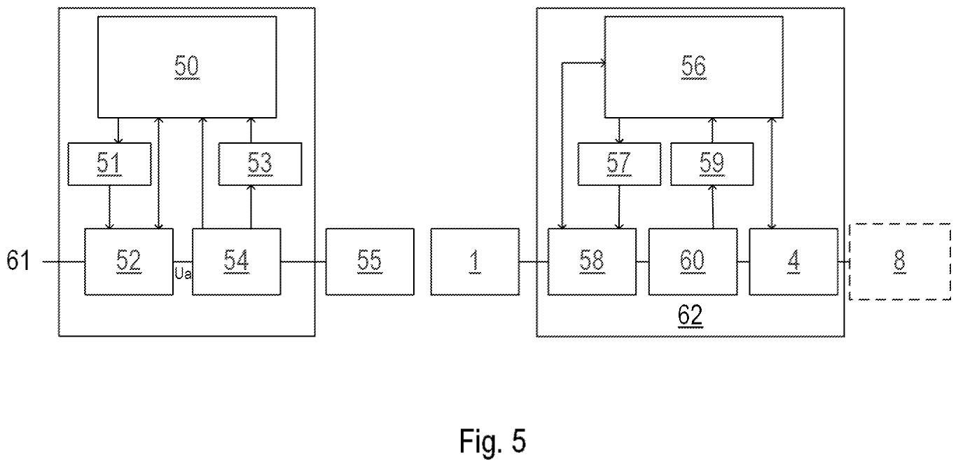

As illustrated in FIG. 5, a DC voltage supply unit supplies an inverter 52, which provides an AC voltage to a gyrator circuit which acts as a current source for a primary coil 63. For this purpose, the at least one capacitor and the at least one inductor are configured to resonate with the frequency of the AC voltage provided by the inverter, since in this case the voltage source-like behavior at the input of the gyrator circuit is converted into a current source-like behavior at the output of the gyrator circuit.

The current flowing through the primary coil 55 is measured by the current sensor 54 of the primary part 63. Alternatively, capturing the voltage applied to the primary coil 55 is also possible.

The communication and control unit 50 provides a data stream to be transferred, which is routed to a modulation unit 51 of the primary part 63. This modulation unit 51 modulates the data stream, for example, as an amplitude-modulated control voltage, which is routed to an inverter 52 such that the voltage applied to the AC-side connection of the inverter 52 is modulated in accordance with the control voltage.

In this manner, the electrical power transferred from the primary coil 55, which is fed by the inverter 52 directly or via the gyrator circuit, to the inductively coupled secondary winding 1 is also modulated accordingly, so that the current curve captured on the secondary side by the current sensor 60 is fed to a demodulation unit 59, which makes the resulting demodulated data stream available to the communication and control unit 56 on the secondary side.

Thus, for the transfer of data, the reduction in voltage on the primary side is detected as a corresponding reduction in current on the secondary side.

The overvoltage protector 58 is realized by the controllable switch 2. When the switch is open, the voltage on the secondary side remains unaffected, and when the switch 2 is closed, there is no longer any resonant transfer, but the current on the secondary side is only equal to the current translated according to the winding ratio of the inductive coupling, insofar as this current penetrates the at least first capacitor 6.

However, if the switch 2 is open, the current driven by the resonant transfer on the secondary side is fed to the rectifier 4, from which the consumer 8, e.g., the load, is supplied.

If the rectifier 4 is arranged as a controllable rectifier, e.g., a synchronous rectifier, it is controlled by the communication and control unit 56 of the secondary part 62.

The communication circuit 10 includes the modulation unit 57 and the part of the communication and control unit 56 provided for transferring data.

Thus, in order to transfer data from the secondary part 62 to the primary part 63, the switch 2 of the overvoltage protector 58 is controlled by the modulation unit 57 of the secondary part 62, thereby influencing the power consumption on the secondary side, which can be detected on the primary side by the current sensor 54.

Thus, for data transfer from the secondary side to the primary side, an overvoltage protector is controlled with an actuation signal which is determined from an OR-link of the data stream signal to be transmitted with the signal intended for activating the overvoltage protector. On the primary side, the current curve or voltage curve caused by this is captured and the data stream to be received is determined therefrom.

For data transfer from the primary side to the secondary side, the current impressed into the primary conductor, e.g., into the primary winding, or the voltage feeding the primary conductor, e.g., the primary winding, is modulated. On the secondary side, the current curve or voltage curve caused by this is captured and the data stream to be received is determined therefrom.

The arrangement of the overvoltage protector as a switch for short-circuiting a part of the oscillating circuit on the secondary side can alternatively also be implemented as a switch for short-circuiting the secondary winding, e.g., the secondary coil. However, in this case the switch must be suitably dimensioned against high breaking currents.

### LIST OF REFERENCE CHARACTERS

1 Secondary winding
2 Controllable switch, e.g., a controllable semiconductor switch
3 Connecting element, e.g., variably equipable bridge, switch, or bridge equipable on a printed circuit board
4 Rectifier, e.g., controlled rectifier
5 Actuator
6 First capacitor
7 Second capacitor
8 Consumer
9 Smoothing capacitor
10 Communication circuit
30 Metal carrier, e.g., made of aluminum or copper
31 Insulation layer
32 Conductor track section
33 Conductor track section
34 Connecting plate
35 Triac, e.g., a triac arranged as an SMD component
50 Communication and control unit
51 Modulation unit
52 Inverter
53 Demodulation unit
54 Current sensor
55 Primary coil
56 Communication and control unit
57 Modulation unit
58 Overvoltage protector
59 Demodulation unit
60 Current sensor
61 Voltage supply
62 Secondary part
63 Primary part
V OR-gate

1-15. (canceled)

16. An installation for inductive transfer of electric power from a primary conductor system of the installation to a secondary winding of a mobile part of the installation, the mobile part being movable relative to the primary conductor system, the secondary winding being connected to capacitors to form an oscillating circuit, comprising:
a sensor adapted to capture a value of a physical variable arranged on the mobile part and adapted to provide a signal to a comparison device that is adapted to generate an output signal depending on a result of a comparison of the value with a threshold value;
an overvoltage protector of the mobile part adapted to be activated and/or deactivated depending on an actuation signal;
a first OR-gate adapted to generate the actuation signal that is provided with a first data flow signal to be transferred from the mobile part to the primary side and with the output signal.

17. The installation according to claim 16, wherein the primary conductor system includes a primary wining and/or a primary conductor arranged in an elongated manner in the installation.

18. The installation according to claim 16, wherein an alternating current having a frequency between 10 KHz and 1 MHz and/or between 20 KHz and 100 kHz, is impressed into the primary conductor system.

19. The installation according to claim 16, wherein the physical variable includes temperature, voltage, and/or current.

20. The installation according to claim 16, wherein a voltage provided to the primary conductor system and/or current impressed into the primary conductor system is modulated with a second data stream.

21. The installation according to claim 16, wherein a voltage provided to the primary conductor system is modulated with a second data stream for transfer of a second data stream from the primary part to the mobile part.

22. The installation according to claim 20, wherein the second data stream is filtered out and/or demodulated from a curve of a current flowing through the secondary winding captured by a sensor or from a curve of a level for voltage induced in the secondary winding or for a voltage occurring at the oscillating circuit captured by a sensor.

23. The installation according to claim 16, wherein the overvoltage protector of the mobile part includes a controllable switch and/or a triac adapted to detune the oscillating circuit and/or short circuit at least a partial region of the oscillating circuit.

24. The installation according to claim 16, wherein the capacitors are connected in series with the secondary winding to form a series circuit adapted to supply an AC/DC converter having a DC-side connection adapted to feed a consumer can be fed from the DC-side connection of the AC/DC converter.

25. The installation according to claim 24, wherein the series circuit is arranged and/or connected at an AC-side connection of the AC/DC converter, and a smoothing capacitor is connected in parallel to the DC-side connection.

26. The installation according to claim 16, wherein the partial region is determinable and/or determined by a connecting element including a variably equipable bridge, a switch, and/or a bridge equipped on a printed circuit board.

27. The installation according to claim 23, wherein the controllable switch includes an SMD component arranged on a printed circuit board having a metal carrier on which a thermally conductive insulation layer is disposed, on a side facing away from the metal carrier, conductor tracks for contacting the SMD component are disposed on the insulation layer.

28. The installation according to claim 23, wherein an actuator of the mobile part is adapted to feed an actuation signal to the controllable switch from an actuator of the mobile part, the actuator being connected to one or more sensors.

29. The installation according to claim 28, wherein the actuator is adapted to generate the actuation signal dependence on a values of physical variables of the mobile part captured by the sensor.

30. The installation according to claim 16, wherein the sensors is adapted to detect a value of temperature of the secondary winding.

31. The installation according to claim 30, wherein the sensor includes an infrared temperature sensor adapted to contactlessly capturing of the temperature of the secondary winding.

32. The installation according to claim 24, wherein the sensor is adapted to detect a value of a temperature of the AC/DC converter.

33. The installation according to claim 32, wherein the sensor includes an infrared temperature sensor adapted to contactlessly capture of the temperature of the AC/DC converter.

34. The installation according to claim 16, wherein the sensor is adapted to capture a value of a voltage applied at the DC-side or AC-side connection of the AC/DC converter.

35. The installation according to claim 16, wherein the sensor is adapted to detect a value of current flowing through the secondary winding.

36. The installation according to claim 24, wherein the sensors is adapted to captures a value of the current entering or exiting the DC-side connection of the AC/DC converter.

37. The installation according to claim 28, wherein the actuator has a comparison device adapted to compare a value of a physical variable of the mobile part captured by the sensor with a threshold value, the actuator adapted to generate the actuation signal for the controllable switch in dependence on an output signal of the comparison device and/or in dependence on a result of the comparison.

38. The installation according to claim 20, wherein the actuator is adapted to monitors a value of a physical variable of the mobile part captured by the sensor for exceeding of an impermissible level of deviation from a setpoint value, and the actuator is adapted to generate an actuation signal for the controllable switch in dependence on an output signal of the monitoring and/or in dependence on a result of the monitoring.

39. The installation according to claim 20, wherein the actuator is adapted to monitor for an impermissibly high level of deviation from a functional relationship and/or a proportionality of values captured by two of the sensors.

40. The installation according to claim 39, wherein the actuator is adapted to generate an actuation signal for the controllable switch in dependence on a result of the monitoring.

41. The installation according to claim 16, wherein an output signal is fed to the first OR-gate via a second OR-gate, to which first OR-gate an enable signal is also fed, so that a transfer of a data packet of a data stream signal that has already commenced is still fully executed after a threshold value has been exceeded.

42. A method of operating an installation, in which electrical power is transferrable from a primary conductor system of the installation to a secondary winding of a mobile part of the installation, the mobile part being movable relative to the primary conductor system, the secondary winding being connected to capacitors to form an oscillating circuit that feeds a rectifier having an output voltage that is supplied to a consumer, comprising:
capturing values of physical variables of the mobile part;
monitoring the captured values for an impermissibly high level of deviation from a functional relationship and/or from a proportionality; and
depending on a result of the monitoring, detuning the oscillating circuit and/or short-circuiting at least a partial region of the oscillating circuit.

43. The method according to claim 42, wherein the detuning and/or the short-circuiting includes supplying an activation pulse to a triac that places the triac into a conducting state, and by a frequency of an alternating current impressed into the primary conductor system being so high that the triac only transitions to a blocking state after an effective current value of the alternating current has disappeared.

44. The method according to claim 43, wherein the frequency is between 10 KHz and 1 MHz.

45. The method according to claim 42, wherein a first one of the physical variables of the mobile part is a temperature of the oscillating circuit and a second one of the physical variables of the mobile part is a temperature of a rectifier, the monitoring including forming a quotient from the captured values of the first one of the physical variables and the second one of the physical variable and monitoring the quotient for an impermissibly high level of deviation from a setpoint value.

46. The method according to claim 42, wherein an output signal is fed to a first OR-gate via a second OR-gate, to which first OR-gate an enable signal is also fed, so that a transfer of a data packet of a data stream signal that has already commenced is still fully executed after a threshold value has been exceeded.
